(19) United States
(12) Patent Application Publication
(10) Pub. No.: US 2025/0219220 A1
(43) Pub. Date: Jul. 3, 2025

(54) POWER STORAGE UNIT

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Shun TAKAMIZAWA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/853,290

(22) PCT Filed: Apr. 4, 2022
(86) PCT No.: PCT/JP2022/017066

§ 371 Date: Oct. 1, 2024

(51) Int. Cl. H01M 50/242; H01G 11/14; H01G 11/78; H01M 50/244; H01M 50/262

(52) U.S. Cl. CPC H01M 50/242; H01G 11/14; H01G 11/78; H01M 50/244; H01M 50/262

(57) ABSTRACT

A power storage unit includes: a power storage pack that includes a power storage element and a holding case that holds the power storage element, a box that accommodates the power storage pack, and a flat metal fitting that is disposed to oppose, in the box metal placement surface of the power storage pack with the power storage pack intervening therebetween, and is fixed to the box and the placement surface and the flat metal fitting form a pressurizing member is that suppress expansion of the power storage element.

### CROSS-REFERENCE TO RELATED APPLICATIONS

This application is the U.S. national stage of PCT/JP2022/017066 filed on Apr. 4, 2023, the contents of which are incorporated herein.

### TECHNICAL FIELD

The present disclosure relates to a power storage unit.

### BACKGROUND

JP 2016-100308A discloses a power storage unit that is mounted in an electric-powered vehicle such as an electric automobile or a hybrid automobile. In this power storage unit, a power storage pack formed by a plurality of power storage elements, which include a lithium ion capacitor, a lithium ion secondary battery, and the like, being respectively held in holding cases made of a synthetic resin is accommodated in a box made of metal, along with a printed board and the like.

Incidentally, in the power storage unit in JP 2016-100308A, a pressurizing member attached to the holding cases of the power storage pack to surround the holding cases is adopted in order to suppress expansion of a power storage element when gas is generated in the power storage element and the internal pressure increases. However, disposing the specially configured pressuring material around the holding cases in order to suppress expansion of the power storage elements increases the complexity of the structure and the size of the power storage unit. For this reason, there has been demand for further improvements.

In view of this, an object of the present disclosure is to provide a power storage unit that can suppress expansion of a power storage element while making it possible to simplify the structure and decreasing the size thereof.

### SUMMARY

A power storage unit according to the present disclosure includes: a power storage pack that includes a power storage element and a holding case that holds the power storage element, a control board that is connected to the power storage pack, a box that accommodates the power storage pack and the control board, and a flat metal fitting that is disposed to oppose, in the box, a metal placement surface for the power storage pack with the power storage pack intervening therebetween, and is fixed to the box, and the placement surface and the flat metal fitting form a pressurizing member that suppresses expansion of the power storage element.

### Advantageous Effects

According to the present disclosure, it is to provide a power storage unit that can suppress expansion of a power storage element while making it possible to simplify the structure and decrease the size thereof.

### BRIEF DESCRIPTION OF DRAWINGS

FIG. 1 is a perspective view showing a power storage unit according to a first embodiment.

FIG. 2 is an exploded perspective view of the power storage unit shown in FIG. 1.

FIG. 3 is an enlarged perspective view showing a power storage pack that constitutes the power storage unit shown in FIG. 1.

FIG. 4 is a perspective view showing an area where a flat metal fitting and a holding case, which constitute the power storage unit shown in FIG. 1, overlap each other.

FIG. 5 is a cross-sectional view taken along the line V-V in FIG. 4.

FIG. 6 is a perspective view showing a flat metal fitting that constitutes a power storage unit according to a second embodiment, with separate spring members attached thereto.

FIG. 7 is a diagram showing the flat metal fitting shown in FIG. 6 before the separate spring members are attached.

FIG. 8 is a perspective view showing main constituent elements of a holding case that constitutes a power storage unit according to a third embodiment.

FIG. 9 is a plan view showing a state where main constituent elements of the holding case shown in FIG. 8 and a flat metal fitting overlap each other.

FIG. 10 is a cross-sectional view taken along the line X-X in FIG. 9.

FIG. 11 is a perspective view showing main constituent elements of a holding case that constitutes a power storage unit according to a fourth embodiment.

FIG. 12 is a cross-sectional view taken along the line XII-XII in FIG. 11.

FIG. 13 is a perspective view showing main constituent elements of a holding case that constitutes a power storage unit according to a fifth embodiment.

### DETAILED DESCRIPTION OF PREFERRED EMBODIMENTS

First, embodiments of the present disclosure will be listed and described.

A power storage unit according to the present disclosure includes: a power storage pack that includes a power storage element and a holding case that holds power storage element, a control board that is connected to the power storage pack, a box that accommodates the power storage pack and the control board, and a flat metal fitting that is disposed to oppose, in the box, a metal placement surface for the power storage pack with the power storage pack intervening therebetween, and is fixed to the box, and the placement surface and the flat metal fitting form a pressurizing member that suppresses expansion of the power storage element.

With such a structure, the pressurizing member that suppresses expansion of the power storage element is formed, with the use of the placement surface of the box on which the power storage pack is placed, by the placement surface and the flat metal fitting cooperating with each other, the flat metal fitting being disposed to oppose the placement surface with the power storage pack therebetween and being fixed to the box. For this reason, the pressurizing member can be formed using existing components without the need for a dedicated pressurizing member as with conventional structures. Moreover, since it is sufficient that the flat metal fitting that is disposed to oppose the placement surface with the power storage pack sandwiched therebetween is fixed to the box, there is no need for a complicated structure for attaching a special pressurizing member to the holding case, or the like. As a result, it is possible to provide a power storage unit that can suppress expansion of a power storage element while simplifying the structure and decreasing the size.

Note that, since the pressurizing member is a member that suppresses expansion of the power storage element, it suffices for the flat metal fitting to be configured to abut on the holding case of the power storage pack at least when the power storage element expands, but the flat metal fitting may include a segment that abuts on the holding case before the power storage element expands.

Preferably, the flat metal fitting includes a fitting-side elastic contact portion that is in elastic contact with the power storage pack. It is possible to advantageously absorb the tolerance between the power storage pack and the space between the opposing surfaces of the placement surface of the box and the flat metal fitting, due to elastic deformation of the fitting-side elastic contact portion provided on the flat metal fitting, and to improve the ease of attachment of the pressurizing member formed by the placement surface and the flat metal fitting to the power storage pack.

Preferably, the fitting-side elastic contact portion is constituted by a spring piece formed by cutting a portion of the flat metal fitting and raising the portion to the power storage pack side. It is possible to form the fitting-side elastic contact portion integrally with the flat metal fitting, and to improve the manufacturability and reduce the cost.

Preferably, the fitting-side elastic contact portion is constituted by a separate spring member that is to be attached to the flat metal fitting. Since the fitting-side elastic contact portion can be constituted by a separate spring member that is to be attached to the flat metal fitting, the fitting-side elastic contact portion can be formed with a high degree of design freedom, and required springiness can be easily realized.

Preferably, the holding case of the power storage pack includes a pack-side elastic contact portion that is in elastic contact with the flat metal fitting. It is possible to advantageously absorb the tolerance between the power storage pack and the space between the opposing surfaces of the placement surface of the box and the flat metal fitting due to elastic deformation of the pack-side elastic contact portion provided on the holding case, and to improve the ease of attachment of the pressurizing member formed by the placement surface and the flat metal fitting to the power storage pack.

Preferably, the pack-side elastic contact portion is constituted by an elastic tongue piece provided integrally with the holding case, on the flat metal fitting side of the holding case. The pack-side elastic contact portion can be formed integrally with the holding case, and it is possible to improve the manufacturability and reduce the cost.

Preferably, the pack-side elastic contact portion is constituted by a separate spring member that is to be attached to the holding case. Since the pack-side elastic contact portion can be constituted by the separate spring member that is to be attached to the holding case, the pack-side elastic contact portion can be formed with a high degree of design freedom, and required springiness can be easily realized.

Preferably, the power storage pack is provided with a guide surface that leads the fitting-side elastic contact portion to a defined position. Since the power storage pack is provided with the guide surface that leads the fitting-side elastic contact portion to the defined position, when the flat metal fitting is placed on the power storage pack before being fixed to the box, for example, the fitting-side elastic contact portion can be easily lead to the defined position by the guide surface even when the fitting-side elastic contact portion is displaced from the defined position. As a result, the flat metal fitting can be easily positioned relative to the power storage pack and the box, thus improving the ease of attachment of the flat metal fitting and, accordingly, the manufacturability of the power storage unit.

Specific examples of a power storage unit according to the present disclosure will be described below with reference to the drawings. Note that the present disclosure is not limited to these examples, but rather is indicated by the claims, and is intended to include all modifications that are within the meanings and the scope that are equivalent to those of the claims.

### First Embodiment

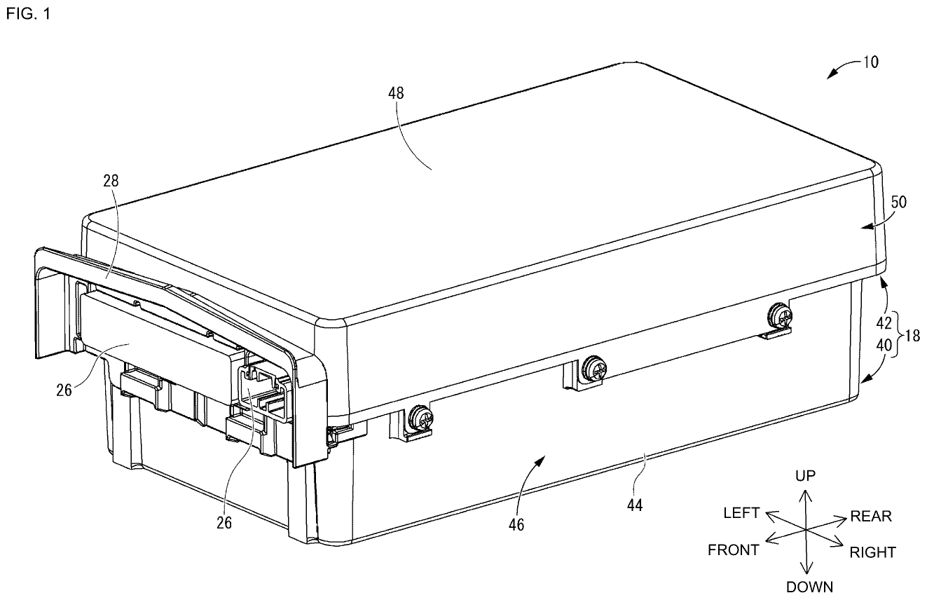

A power storage unit 10 according to a first embodiment of the present disclosure will be described below with reference to FIGS. 1 to 5. In the event of a power failure in an electric automobile, a hybrid automobile, or the like, the power storage unit 10 according to the present embodiment is used as a power storage unit or a power source unit for multi-functional system backup for steer-by-wire (SBW), a brake, electronic power steering (EPS), automated driving, and the like, and is a relatively large-capacity power storage unit. Note that, although the power storage unit 10 can be disposed in any orientation, the following description is given based on the up-down, right and left, and front-rear directions shown in FIG. 1. In addition, in the following description, only some of a plurality of identical members are given reference numerals, and reference numerals of the other members may be omitted.

### Power Storage Unit 10

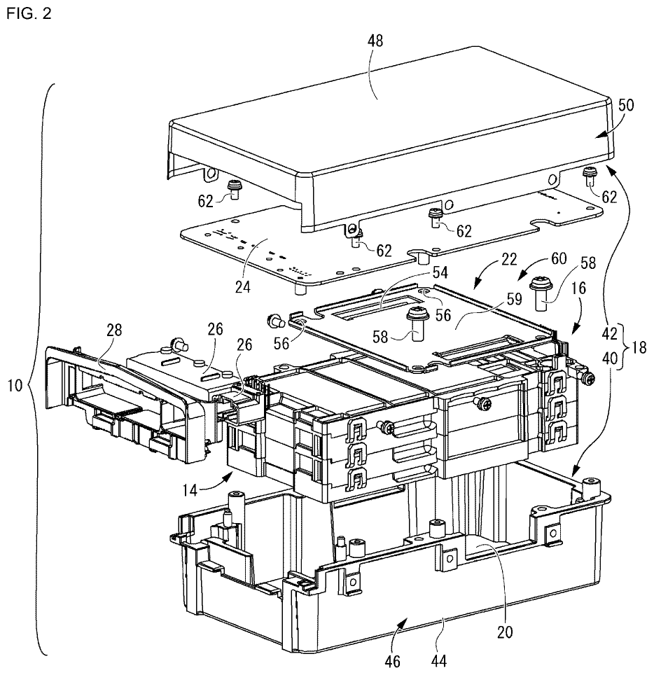

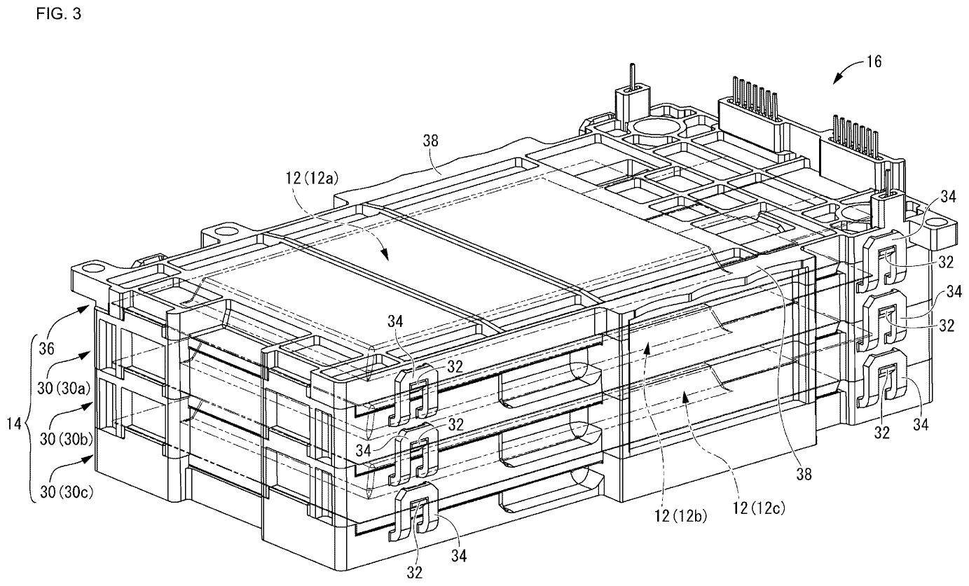

Also as shown in FIGS. 2 and 3, the power storage unit 10 includes a power storage pack 16 that includes power storage elements 12 and a holding case 14 that holds the power storage elements 12, a box 18 that accommodates the power storage pack 16, and a flat metal fitting 22 that is disposed to oppose, in the box 18, a metal placement surface 20 for the power storage pack 16 with the power storage pack 16 intervening therebetween, and is fixed to the box 18.

In addition to the power storage pack 16 and the flat metal fitting 22, the box 18 accommodates a control board 24 that is electrically connected to the power storage pack 16 via an appropriate connector, terminal, or the like, and connectors 26 that are electrically connected to the control board 24. The connectors 26 are exposed from a front opening portion of the box 18, and, by connectors or the like of a partner device (not illustrated) being electrically connected to the connectors 26, the power storage unit 10 and the partner device are electrically connected to each other. Note that a connector cover 28 is provided over the front opening portion of the box 18, preventing water from entering the box 18.

### Power Storage Pack 16

A conventionally known capacitor or the like can be adopted for each power storage element 12, but, in the first embodiment, as shown in FIG. 3, the power storage elements 12 having a substantially flat plate shape are adopted. The power storage elements 12 are held in holders 30. Each holder 30 is made of an insulative synthetic resin. The outer shape of the holder 30 is a substantially rectangular with a size in the front-rear direction larger than a size in the left-right direction.

In the first embodiment, three power storage elements 12 are provided in the power storage pack 16. The power storage elements 12 are spaced apart from each other in the up-down direction, and the power storage elements 12 (a first power storage element 12a, a second power storage element 12b, and a third power storage element 12c in descending order) are respectively held in the holders 30 (a first holder 30a, a second holder 30b, and a third holder 30c in descending order), respectively. The holders 30 (the first to third holders 30a to 30c) each have an engagement claw portions 32 and/or engagement frame bodies 34 on outer peripheral surfaces thereof, and the first to third holders 30a to 30c that respectively hold the first to third power storage elements 12a to 12c are overlaid on each other in the up-down direction as shown in FIGS. 2 and 3, and are releasably attached by the engagement claw portions 32 and the engagement frame bodies 34. Note that appropriate insulating structures are provided between the power storage elements 12 vertically adjacent to each other and on the lower surface of the third power storage element 12c, which is the lowest power storage element, such that the power storage elements 12 that oppose each other in the up-down direction are not electrically conductive to each other and the third power storage element 12c and the box 18 (a lower case 40 to be described later) on which the power storage pack 16 is placed are not electrically conductive to each other.

A case lid portion 36 is overlaid on and attached to the first holder 30a, which is the uppermost holder, from above. The case lid portion 36 is formed of an insulative synthetic resin, and has a substantially rectangular flat plate shape, which is substantially the same outer shape as the holders 30 (the first to third holders 30a to 30c). Engagement claw portions 32 are provided on outer peripheral surfaces of the case lid portion 36, and are engaged with the engagement frame bodies 34 of the first holder 30a, and the case lid portion 36 and the first holder 30a are releasably attached to each other. By the case lid portion 36 being attached to the first holder 30a from above in this manner, the first power storage element 12a held in the first holder 30a is covered by the insulative case lid portion 36 from above, such that the first power storage element 12a is not electrically conductive with the flat metal fitting 22 that opposes the first power storage element 12a in the up-down direction as will be described later. Therefore, in the first embodiment, in the power storage pack 16, the holding case 14 that hold the power storage elements 12 (the first to third power storage elements 12a to 12c) is configured by including the holders 30 (the first to third holders 30a to 30c) and the case lid portion 36.

Note that, at intermediate portions in the front-rear direction of the case lid portion 36, portions that protrude outward in the left-right direction are formed with a predetermined size in the front-rear direction, and abutting surfaces 38 on which fitting-side elastic contact portions 54 of the flat metal fitting 22, which will be described later, elastically abut are formed by the upper surfaces of the portions that protrude outward in the left-right direction.

In addition, for example, a bus bar that includes terminals protruding upward and the like is electrically connected to the power storage elements 12 (the first to third power storage elements 12a to 12c), and these terminals are directly or in directly connected to the control board 24 positioned above the power storage pack 16, through the holders 30 and/or the case lid portion 36 positioned above the power storage elements 12, to establish electrical continuity.

### Box 18

The box 18 is constituted by the lower case 40 that has a substantially box-shape and is open upward, and an upper case 42 that has a substantially box-shape and is open downward. That is to say, the upper case 42 is overlaid on the lower case 40 from above to cover the upward opening portion of the lower case 40, and the lower case 40 and the upper case 42 are fixed to each other, thereby forming the box 18. In the first embodiment, both the lower case 40 and the upper case 42 are made of metal.

Specifically, the lower case 40 includes a substantially rectangular bottom wall portion 44, and a lower peripheral wall portion 46 that protrudes upward from the outer peripheral edge portion of the bottom wall portion 44. In addition, the upper case 42 includes a substantially rectangular upper bottom wall portion 48, and an upper peripheral wall portion 50 that protrudes downward from the outer peripheral edge portion of the upper bottom wall portion 48. In addition, the power storage pack 16 is placed on the bottom wall portion 44 of the lower case 40 such that the power storage pack 16 is accommodated in the lower case 40, and the upper surface of the bottom wall portion 44 of the lower case 40 serves as the placement surface 20 on which the power storage pack 16 is placed.

### Flat Metal Fitting 22

The flat metal fitting 22 is substantially square in planar view, and is made of metal such as iron (or an iron alloy) and aluminum (or an aluminum alloy). The outer peripheral edge portion of the flat metal fitting 22 is bent upward, thus improving the rigidity.

On the two sides in the left-right direction of the flat metal fitting 22, substantially rectangular through windows 52 that pass through the flat metal fitting 22 in the plate thickness direction (the up-down direction) are respectively provided. The through windows 52 are formed with predetermined sizes in the front-rear direction and the left-right direction, at intermediate portions in the front-rear direction of the flat metal fitting 22.

### Fitting-side Elastic Contact Portions 54

The fitting-side elastic contact portions 54 that are curved to form downward protrusions while protruding outward in the left-right direction are provided on inner peripheral surfaces on the inner side in the left-right direction of the through windows 52, respectively. The fitting-side elastic contact portions 54 are smaller than the through windows 52 in the front-rear direction, and a space (gap) is provided on three sides (the two sides in the front-rear direction and the outer side in the left-right direction) around each of the fitting-side elastic contact portions 54. Accordingly, the fitting-side elastic contact portions 54 are elastically deformable in the thickness direction. In the first embodiment, the fitting-side elastic contact portions 54 are each configured by a spring piece formed by cutting a portion of the flat metal fitting 22 and raising the portion downward, that is to say, to the power storage pack 16 side as will be described later.

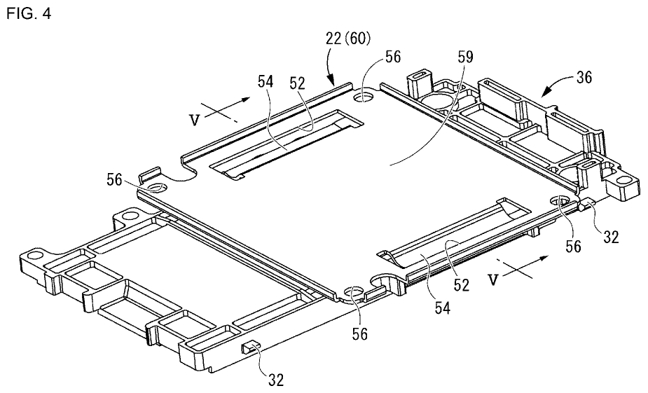

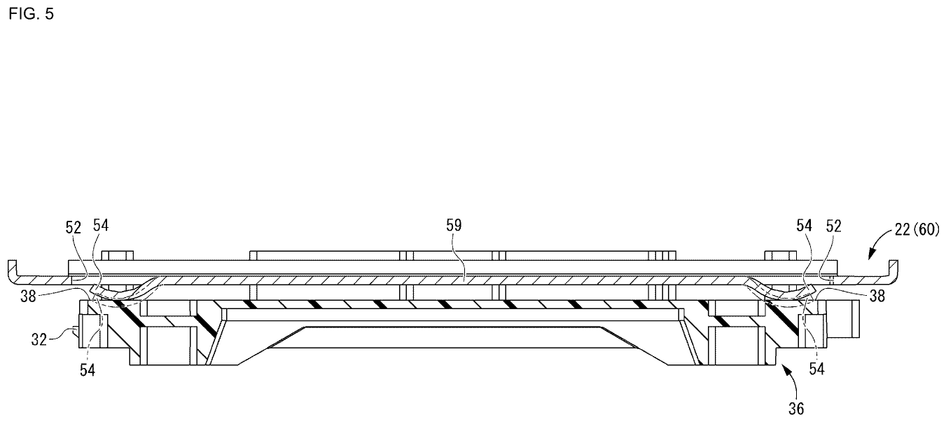

Bolt insertion holes 56 are formed at the four corners of the flat metal fitting 22, and bolts 58, which are inserted into the bolt insertion holes 56, are fastened to the lower peripheral wall portion 46 of the lower case 40 of the box 18. Accordingly, the flat metal fitting 22 is fixed to the upward opening portion of the lower case 40 that accommodates the power storage pack 16, from above such that the power storage pack 16 is covered. As a result, the flat metal fitting 22 and the case lid portion 36 that forms an upper end portion of the power storage pack 16 oppose each other in the up-down direction, and the fitting-side elastic contact portions 54 that protrude downward from the flat metal fitting 22 are in elastic contact with the abutting surfaces 38 of the case lid portion 36. FIGS. 4 and 5 show a state where the flat metal fitting 22 and the case lid portion 36 oppose each other in the up-down direction and the fitting-side elastic contact portions 54 and the abutting surfaces 38 are in elastic contact with each other, respectively.

That is to say, by the flat metal fitting 22 being fixed to the upward opening portion of the lower case 40 using the bolts 58, the fitting-side elastic contact portions 54 are pressed to the abutting surfaces 38, and the fitting-side elastic contact portions 54 elastically deform upward. Note that FIG. 5 shows a state before the fitting-side elastic contact portions 54 elastically deform, which is indicated by two-pointed chain lines. Due to an elastic restoring force of the fitting-side elastic contact portions 54, the fitting-side elastic contact portions 54 are pressed against the abutting surfaces 38, and the case lid portion 36 and, accordingly, the power storage pack 16 are biased downward. As a result, the power storage pack 16 is sandwiched between the upper surface (the placement surface 20) of the bottom wall portion 44 of the lower case 40 of the box 18 and the flat metal fitting 22, in the up-down direction.

### Pressurizing Member 60

Moreover, as will be described later, when the power storage elements 12 (the first third power storage elements 12a to 12c) expand, an intermediate portion in the left-right direction of the case lid portion 36 bulges upward and abuts on an intermediate portion in the left-right direction of the flat metal fitting 22. Accordingly, an expansion suppressing portion 59 is formed by the intermediate portion in the left right direction of the flat metal fitting 22 (between the fitting-side elastic contact portions 54 in the left-right direction), and the pressurizing member 60 that suppress expansion of the power storage elements 12 (the first third power storage elements 12a to 12c) is formed by the placement surface 20 and the flat metal fitting 22 (particularly, the expansion suppressing portion 59). Note that, also as shown in FIG. 5, in a state where the power storage elements 12 (the first third power storage elements 12a to 12c) are not expanding, the intermediate portion in the left-right direction of the flat metal fitting 22 (the expansion suppressing portion 59) and the intermediate portion in the left-right direction of the case lid portion 36 are spaced apart from each other in the up-down direction.

### Process of Assembling Power Storage Unit 10

Next, a specific example of a process of assembling the power storage unit 10 will be described. Note that the process of attaching the power storage unit 10 is not limited to the following.

First, the power storage elements 12 (the first third power storage elements 12a to 12c) are respectively accommodated in the holders (the first to third holders 30a to 30c), and the first to third holders 30a to 30c are overlaid on and attached to each other in the up-down direction with appropriate insulation structures therebetween. In addition, the case lid portion 36 is overlaid on and attached to the first holder 30a in which the first power storage element 12a is held, from above. Accordingly, the power storage pack 16 is completed.

This power storage pack 16 is placed on the upper surface (the placement surface 20) of the bottom wall portion 44 of the lower case 40, and the power storage pack 16 is accommodated in the lower case 40. The flat metal fitting 22 is then overlaid on the power storage pack 16 from above, and the flat metal fitting 22 is fixed to the lower case 40 using the bolts 58. Accordingly, the fitting-side elastic contact portions 54 are pressed to the abutting surfaces 38 of the case lid portion 36, and the fitting-side elastic contact portions 54 elastically deform upward. As a result, the power storage pack 16 is sandwiched between the placement surface 20 and the flat metal fitting 22 in the up-down direction.

The control board 24 is then overlaid on the flat metal fitting 22 from above, and is fixed thereto using bolts 62 to cover the upward opening portion of the lower case 40, and terminals and the like that protrude upward from the power storage pack 16 are electrically connected to the control board 24. Furthermore, in a state where the connectors 26 are electrically connected to the control board 24, the connectors 26 are fixed to the lower case 40. Note that the connectors 26 may be mounted on the control board 24 in advance, or the control board 24 and the connectors 26 may be integrally fixed to the lower case 40. The connector cover 28 is then overlaid on and is fixed to the lower case 40 such that the connectors 26 are covered. In this manner, in a state where the power storage pack 16, the flat metal fitting 22, the control board 24, the connectors 26, and the connector cover 28 are fixed to the lower case 40, the upper case 42 is overlaid on and fixed to the lower case 40 from above. Accordingly, the power storage unit 10 is completed.

With the power storage unit 10 according to the first embodiment manufactured as described above, the power storage pack 16 is sandwiched between the placement surface 20 of the lower case 40 that constitutes the box 18 and the flat metal fitting 22 fixed to the lower case 40, in the up-down direction. Particularly, for example, when gas is generated in the power storage elements 12, which have a substantially flat plate shape, the power storage elements 12 are likely to expand in the up-down direction, which is the plate thickness direction, but both the lower case 40 and the flat metal fitting 22 that sandwich the power storage pack 16 in the up-down direction are made of metal, and have sufficient rigidity, and thus the placement surface 20 and the intermediate portion in the left-right direction of the flat metal fitting 22 (the expansion suppressing portion 59) act as the pressurizing member 60, suppressing expansion of the power storage elements 12. In addition, the lower case 40 (the placement surface 20) that constitutes the box 18 of the power storage unit 10 and the flat metal fitting 22 that is fixed to the lower case 40 and is positioned in the box 18 are used as the pressurizing member 60, and thus an increase in the size of the power storage unit 10 is also avoided without providing a pressurizing member having a complicated structure.

The flat metal fitting 22 includes the fitting-side elastic contact portions 54 that come into elastic contact with the power storage pack 16. Due to elastic deformation of the fitting-side elastic contact portions 54, the tolerance of the members can be absorbed, thus improving the ease of assembly. In addition, the power storage pack 16 is biased downward due to the fitting-side elastic contact portions 54, and is stably accommodated into the lower case 40 without being loosened. Particularly in the first embodiment, the power storage pack 16 is configured by attaching the holders 30 (the first to third holders 30a to 30c) that hold the power storage elements 12 (the first third power storage elements 12a to 12c) and the case lid portion 36 to each other. For this reason, by the case lid portion 36 being pressed by the fitting-side elastic contact portions 54 from above, looseness between the case lid portion 36 and the first holder 30a and looseness between the holders 30 can also be prevented.

In the first embodiment, the fitting-side elastic contact portions 54 are each configured by a spring piece formed by cutting a portion of the flat metal fitting 22 and raising the portion downward, namely to the power storage pack 16 side. Accordingly, the fitting-side elastic contact portions 54 can be formed integrally with the flat metal fitting 22, making it possible to form the fitting-side elastic contact portions 54 easily and inexpensively, and accordingly improving the manufacturability of the power storage unit 10 and reducing the cost.

### Second Embodiment

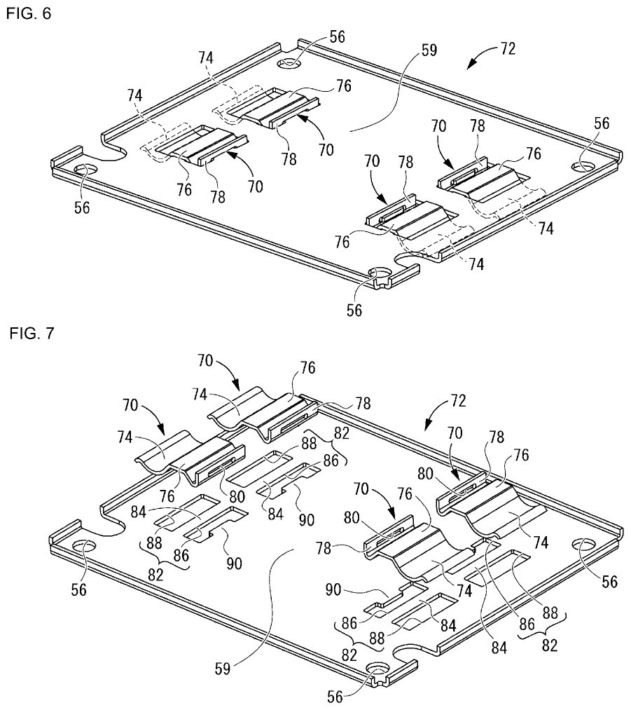

Next, a power storage unit according to a second embodiment of the present disclosure will be described with reference to FIGS. 6 and 7. In the second embodiment, only the shape of the flat metal fitting 72 that includes fitting-side elastic contact portions 70 is different from that of the power storage unit 10 according to the first embodiment, and thus illustration of the other portions is omitted. In the following description, members and segments that are substantially the same as those of the above embodiments are given the same reference numerals as the above embodiments in drawings, and thereby a detailed description thereof is omitted.

### Fitting-Side Elastic Contact Portions 70

In the first embodiment, the fitting-side elastic contact portions 54 are formed integrally with the flat metal fitting 22, but, in the second embodiment, the fitting-side elastic contact portions 70 are configured by spring members separate from the flat metal fitting 72, and the fitting-side elastic contact portions 70 are attached to the flat metal fitting 72. Note that, in the second embodiment, on each of the two sides in the left right direction of the flat metal fitting 72, the fitting-side elastic contact portions 70 are attached at two locations spaced apart from each other in the front-rear direction, but the fitting-side elastic contact portions 70 are similar in shape to each other, and thus one of the fitting-side elastic contact portions 70 will be described.

The fitting-side elastic contact portion 70 can be formed, for example, by bending a substantially rectangular metal plate through press working or the like, and is elongated in the front-rear direction overall. One end portion of the fitting-side elastic contact portion 70 is provided with a curved portion 74 that practically has the function of a spring, and this curved portion 74 is curved to form a downward protrusion. A flat portion 76 that extends parallel to the flat metal fitting 72 is provided continuously to the curved portion 74, and the other end portion of the fitting-side elastic contact portion 70 is provided with a perpendicular portion 78 that extends in a direction perpendicular to the flat metal fitting 72. The perpendicular portion 78 is provided with a substantially rectangular engagement hole 80 that extends in the front-rear direction and passes therethrough in the left-right direction.

### Flat Metal Fitting 72

At locations of the flat metal fitting 72 where the fitting-side elastic contact portions 70 are attached, through windows 82 that have a sufficient size in the front-rear direction for inserting the fitting-side elastic contact portions 70 are formed with a predetermined size in the left-right direction, and pass through the flat metal fitting 72 in the plate thickness direction (the up-down direction). Each of the through windows 82 is partitioned at an intermediate portion in the left-right direction thereof by a partition portion 84 extending in the front-rear direction, into a first window portion 86 on the inner side in the left-right direction and a second window portion 88 on the outer side in the left-right direction. The inner peripheral surface on the inner side in the left-right direction of the through window 82 (that is to say, the inner peripheral surface on the inner side in the left-right direction of the first window portion 86) is provided with an engagement protruding portion 90 that protrudes outward in the left-right direction into the first window portion 86.

When attaching the fitting-side elastic contact portion 70 described above to the flat metal fitting 72, the fitting-side elastic contact portion 70 is inserted into the second window portion 88 of the through window 82 from the curved portion 74 side, namely the one end portion side of the fitting-side elastic contact portion 70, the fitting-side elastic contact portion 70 is rotated relative to the flat metal fitting 72 around a rotation axis extending in the front-rear direction while the fitting-side elastic contact portion 70 is inserted into the second window portion 88, such that the flat portion 76 of the fitting-side elastic contact portion 70 and the partition portion 84 of the through window 82 are disposed parallel to each other. After that, by pressing the fitting-side elastic contact portion 70 into the flat metal fitting 72 from above such that the flat portion 76 and the partition portion 84 overlap each other, the engagement protruding portion 90 is engaged with the engagement hole 80. Accordingly, in addition to recess/projection fitting between the engagement protruding portion 90 and the engagement hole 80, the flat portion 76 is supported on the partition portion 84, and thus the fitting-side elastic contact portion 70 is stably attached to the flat metal fitting 72. Then, in a state where the fitting-side elastic contact portion 70 is attached to the flat metal fitting 72, the curved portion 74 is disposed in a state of forming a downward protrusion, below the flat metal fitting 72. Note that, after the fitting-side elastic contact portion 70 is attached to the flat metal fitting 72 as described above, and the fitting-side elastic contact portion 70 may be more firmly fixed through welding, adhesion, or the like.

Also in the second embodiment, the flat metal fitting 72 that includes the fitting-side elastic contact portions 70 opposes and is fixed to the case lid portion 36 of the power storage pack 16 in the up-down direction, and thereby the curved portions 74 of the fitting-side elastic contact portions 70 are pressed to the abutting surfaces 38 of the case lid portion 36, respectively. Accordingly, effects similar to those of the first embodiment can be exerted. Particularly, by forming the fitting-side elastic contact portions 70 separately from the flat metal fitting 72, the material, shape, and the like of the fitting-side elastic contact portions 70 can be appropriately changed in accordance with required springiness, and the tolerance absorption effect by the fitting-side elastic contact portions 70, the looseness prevention effect of the power storage pack 16, and the like can also be exerted in a more stable manner.

### Third Embodiment

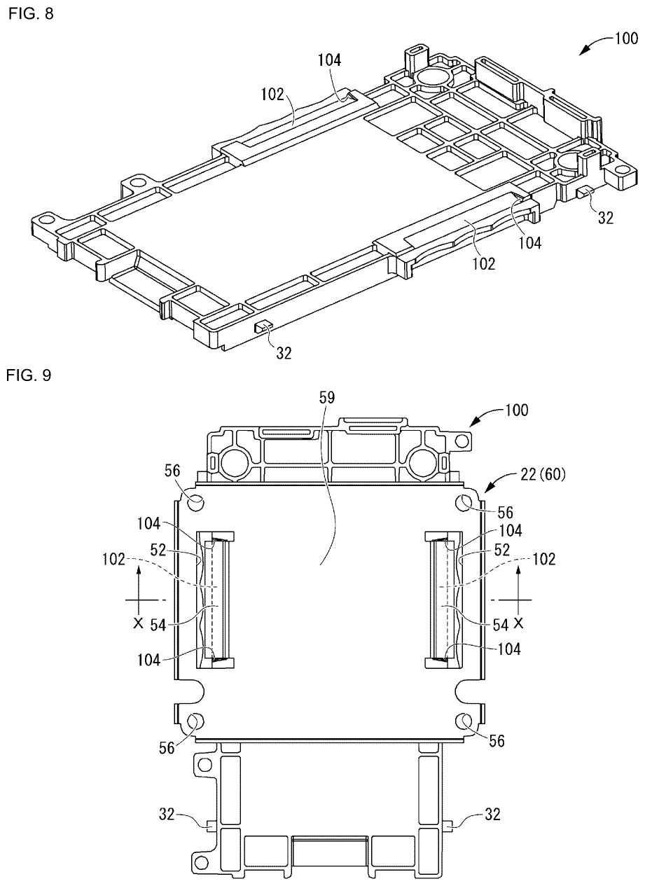

Next, a power storage unit according to a third embodiment of the present disclosure will be described with reference to FIGS. 8 to 10. In the third embodiment, only the shape of a case lid portion 100 that constitutes the power storage pack 16 is different from that of the power storage unit 10 according to the first embodiment, and thus illustration of the other portions is omitted. Similarly to the first embodiment, for example, the holder 30 (the first holder 30a) that holds the power storage element 12 (the first power storage element 12a) can be attached to this case lid portion 100 from below, and this case lid portion 100 can be disposed in a state of being opposed by the flat metal fitting 22, whose shape is similar to that of the first embodiment, in the up-down direction from above.

### Guide Surfaces 102

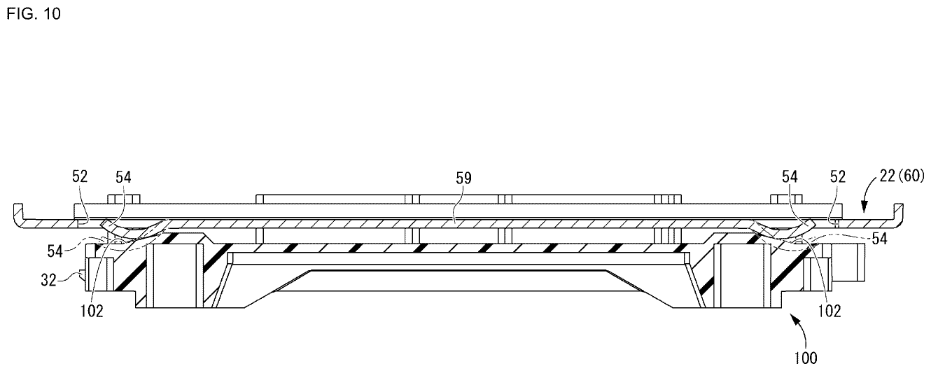

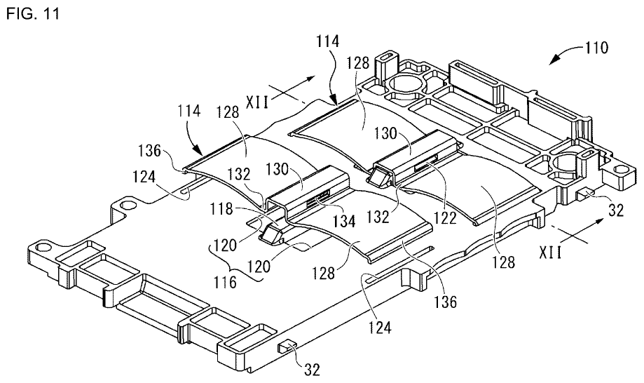

In the third embodiment, on the two sides in the left-right direction of an intermediate portion in the front-rear direction of the case lid portion 100, guide surfaces 102 that are gradually inclined downward toward the outer side in the left-right direction are provided. In addition, on the two sides in the front-rear direction of each of the guide surfaces 102, inclined surfaces 104 that are gradually inclined outward in the front-rear direction toward the upper side are provided. These inclined surfaces 104 are also inclined outward in the front-rear direction, toward the outer sides in the left-right direction, and the minimum opposing distance between the inclined surfaces 104 that oppose each other in the front-rear direction (that is to say, opposing distance in the front-rear direction between end portions on the inner side in the left-right direction of the inclined surfaces 104) is substantially the same or slightly larger than the size in the front-rear direction of the fitting-side elastic contact portions 54 of the flat metal fitting 22. FIGS. 9 and 10 show a state where the case lid portion 100 and the flat metal fitting 22 that are shaped in this manner oppose each other in the up-down direction, and the fitting-side elastic contact portions 54 of the flat metal fitting 22 and the case lid portion 100 are in elastic contact with each other. Along with this state, FIG. 10 shows a state where the fitting-side elastic contact portions 54 do not elastically deform, which is indicated by the two-pointed chain lines.

In the third embodiment, by the guide surfaces 102 being respectively provided on the two sides in the left-right direction of the case lid portion 100, the fitting-side elastic contact portions 54 and the guide surfaces 102 respectively abut on each other before the flat metal fitting 22 is fixed to the lower case 40 using the bolts 58. Moreover, similarly to the first embodiment, in the third embodiment, by the flat metal fitting 22 being fixed to the upward opening portion of the lower case 40 using the bolts 58, the fitting-side elastic contact portions 54 are respectively pressed to the guide surfaces 102, and the fitting-side elastic contact portions 54 elastically deform upward, as shown in FIG. 10. Due to an elastic restoring force of the fitting-side elastic contact portions 54, the fitting-side elastic contact portions 54 are respectively pressed against the guide surfaces 102, and the case lid portion 100, and, accordingly, the power storage pack 16 are biased downward.

Also in the power storage unit according to the third embodiment that includes the case lid portion 100 described above, effects similar to those of the power storage unit 10 according to the first embodiment can be exerted. Particularly, in the third embodiment, the guide surfaces 102 are respectively provided on the two sides in the left-right direction of the case lid portion 100 such that, in a stage where the flat metal fitting 22 is placed on the case lid portion 100 (a stage before the flat metal fitting 22 is fixed by the bolts 58), the fitting-side elastic contact portions 54 and the guide surfaces 102 abut on each other in the left-right direction. Accordingly, the fitting side elastic contact portions 54 are respectively guided to the guide surfaces 102, and the flat metal fitting 22 is held on the case lid portion 100 at a defined position in the left-right direction. In addition, on the two sides in the front-rear direction of each of the guide surfaces 102, the inclined surfaces 104 that are gradually inclined outward in the front-rear direction toward the upper side are provided, and the fitting-side elastic contact portions 54 are also guided to and held at defined positions in the front-rear direction by these inclined surfaces 104. That is to say, when the flat metal fitting 22 is attached, by placing the flat metal fitting 22 on the case lid portion 100, the fitting-side elastic contact portions 54 of the flat metal fitting 22 are lead to defined recessed positions formed in the case lid portion 100 by the guide surfaces 102 and the inclined surfaces 104, and the flat metal fitting 22 is held in a state of being positioned on the case lid portion 100, thus improving the ease of assembly.

### Fourth Embodiment

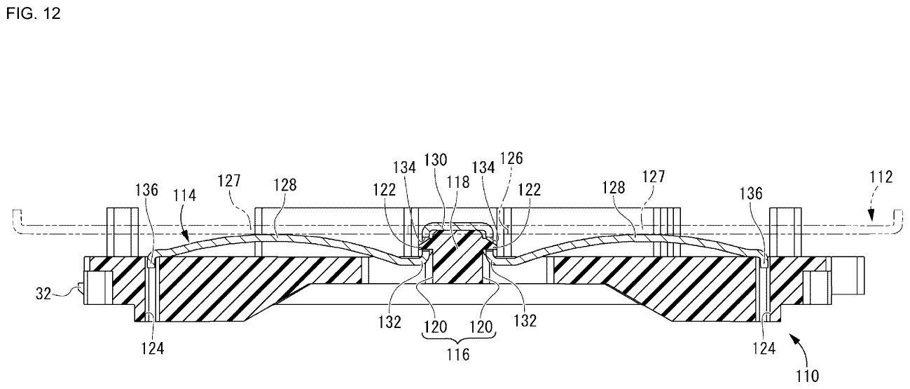

Next, a power storage unit according to a fourth embodiment of the present disclosure will be described with reference to FIGS. 11 and 12. In the fourth embodiment, the shape of a case lid portion 110 that constitutes a holding case of a power storage pack is different from that of the power storage unit 10 according to the first embodiment, and their basic structures are similar, and thus illustration of the other portions is omitted. Similarly to the first embodiment, for example, the holder 30 (the first holder 30a) in which the power storage element 12 (the first power storage element 12a) is held can be attached to this case lid portion 110 from below, and the case lid portion 110 can be disposed in a state of being opposed by a flat metal fitting 112 (illustrated using the two-pointed chain line in FIG. 12) in the up-down direction from above, similarly to the first embodiment.

In the first to third embodiments, the flat metal fittings 22 and 72 respectively include the fitting-side elastic contact portions 54 and 70 that come into elastic contact with the case lid portions 36 and 100 that constitute the power storage pack 16, but, in the fourth embodiment, the case lid portion 110 that constitutes a power storage pack includes pack-side elastic contact portions 114 that come into elastic contact with the flat metal fitting 112. Particularly, in the fourth embodiment, the pack-side elastic contact portions 114 are each configured by a spring member separate from the case lid portion 110 in a holding case, and the pack-side elastic contact portions 114 are attached to the case lid portion 110. In addition, in the fourth embodiment, a pair of pack-side elastic contact portions 114 are spaced apart from each other in the front-rear direction. Note that FIG. 11 illustrates the pack-side elastic contact portion 114 on the front side before being attached to the case lid portion 110, and the pack-side elastic contact portion 114 on the rear side in a state of being attached to the case lid portion 110.

Substantially rectangular through windows 116 are provided in a central portion in the left-right direction of the case lid portion 110, at positions at which the pack-side elastic contact portions 114 are attached, respectively. That is to say, a pair of through windows 116 that are spaced apart from each other in the front-rear direction pass through the case lid portion 110 in the thickness direction (the up-down direction). A partition portion 118 extending in the front-rear direction is provided in a central portion in the left-right direction of each of the through windows 116, and the through window 116 is separated by this partition portion 118 into a pair of insertion holes 120 spaced apart from each other in the left-right direction. The partition portion 118 protrudes upward beyond the upper surface of the case lid portion 110, and a pair of engagement protruding portions 122 that protrude to the two sides in the left-right direction are provided on this partition portion 118 protruding upward. In addition, in the case lid portion 110, a pair of engagement grooves 124 extending in the front-rear direction are respectively provided in the two end portions in the left-right direction at a position where each of the through windows 116 is formed. The through windows 116 and the engagement grooves 124 are formed with substantially the same size in the front-rear direction.

### Flat Metal Fitting 112

The flat metal fitting 112 according to the fourth embodiment is not provided with any fitting-side elastic contact portion, and can have a substantially flat plate shape overall, for example. Substantially rectangular opening portions 126 for avoiding interference of the partition portions 118 and later-described coupling portions 130 are provided in central portions in the left-right direction of the flat metal fitting 112, and are spaced apart from each other in the front-rear direction. Note that, in the fourth embodiment, for example, in the flat metal fitting 112, expansion suppressing portions 127 are formed in portions on the right and left sides of the opening portions 126, and, when the case lid portion 110 bulges upward in accordance with expansion of the power storage elements 12, portions of the case lid portion 110 that are on the right and left sides relative to the through windows 116 abut on the expansion suppressing portions 127 via curved portions 128 of the pack-side elastic contact portions 114 to be described later, thereby suppressing expansion of the power storage elements 12.

### Pack-Side Elastic Contact Portions 114

The front and rear pack-side elastic contact portions 114 has the same shape, and thus one of the pack-side elastic contact portions 114 will be described below. The pack-side elastic contact portion 114 can be formed, for example, by bending a substantially rectangular metal plate through press working or the like, and is elongated in the left-right direction overall. The curved portions 128 that practically have the function of a spring are provided on the two sides in the lengthwise direction (left-right direction) of the pack-side elastic contact portion 114, and these curved portions 128 are curved to form upward protrusions. The curved portions 128 on the two sides are coupled by the coupling portion 130 that has a substantially gutter shape that is open downward to cover the partition portion 118 from above, and lower end portions on the right and left sides of the coupling portion 130 and the curved portions 128 on the right and left sides are respectively connected by bent portions 132. In addition, engagement holes 134 that are engaged with the engagement protruding portions 122 are provided on wall portions on the right and left sides that constitute the coupling portion 130. Furthermore, engagement claw portions 136 that protrude downward are provided in end portions on the opposite side to a side on which the curved portions 128 are coupled to the coupling portion 130 (the two end portions in the left-right direction).

When the pack-side elastic contact portions 114 described above are attached to the case lid portion 110, the pack-side elastic contact portions 114 and the case lid portion 110 oppose each other in the up-down direction such that the coupling portions 130 cover the partition portions 118 from above, as shown in FIG. 11. By pressing the pack-side elastic contact portions 114 from above in this state, bent portions 132 that are each a connection portion between the curved portion 128 and the coupling portion 130 are inserted into a pair of insertion holes 120 in central portions in the left-right direction, and the engagement claw portions 136 are inserted into a pair of engagement grooves 124 in the two end portions in the left-right direction. In addition, the coupling portions 130 are overlaid on the partition portions 118 from above, and the engagement protruding portions 122 are engaged with the engagement holes 134. Accordingly, in addition to recess/projection fitting between the engagement protruding portions 122 and the engagement holes 134, the engagement claw portions 136 are inserted into the engagement grooves 124, and thus, while effectively preventing displacement of the pack-side elastic contact portions 114 relative to the case lid portion 110 in the left-right direction, the pack-side elastic contact portions 114 are stably attached to the case lid portion 110. Moreover, in a state where the pack-side elastic contact portions 114 are attached to the case lid portion 110, the curved portions 128 are disposed in a state of forming upward protrusions. Note that the pack-side elastic contact portions 114 are attached to the case lid portion 110 as described above, and may be then more firmly fixed to the case lid portion 110 through welding, adhesion, or the like.

As shown in FIG. 12, on the case lid portion 110 to which the pack-side elastic contact portions 114 are attached in this manner, while the partition portions 118 and the coupling portions 130 are inserted into the opening portions 126, the flat metal fitting 112 and the case lid portion 110 are disposed to oppose each other in the up-down direction. Accordingly, the flat metal fitting 112 and the curved portions 128 are overlaid on each other in the up-down direction. From this state, by fixing the flat metal fitting 112 to the upward opening portion of the lower case 40 using the bolts 58, the curved portions 128 are pressed against the flat metal fitting 112 from below and come into elastic contact with the flat metal fitting 112. As a result, the curved portions 128 elastically deform downward, and due to an elastic restoring force against this elastic deformation, the case lid portion 110, that is to say, the power storage pack is biased downward, namely in a direction separating away from the flat metal fitting 112.

Also with the power storage unit according to the fourth embodiment that includes the case lid portion 110 described above, effects similar to those of the power storage unit 10 according to the first embodiment can be exerted. Particularly, by forming the pack-side elastic contact portions 114 separately from the case lid portion 110, it is possible to appropriately change the material, shape, and the like of the pack-side elastic contact portions 114 in accordance with required springiness, and, for example, the pack-side elastic contact portions 114 can also be made of metal. Accordingly, the tolerance absorption effect by the pack-side elastic contact portions 114, the looseness prevention effect of the power storage pack, and the like can also be exerted in a more stable manner.

### Fifth Embodiment

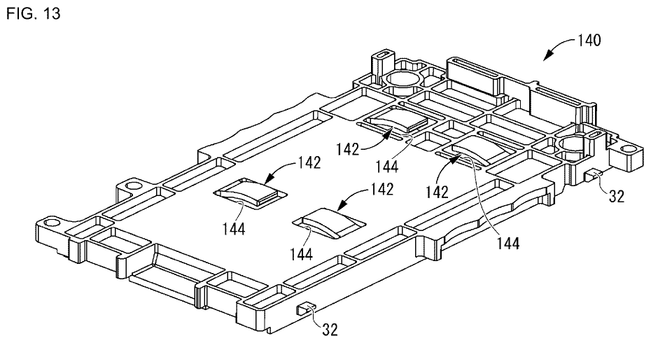

Next, a power storage unit according to a fifth embodiment of the present disclosure will be described with reference to FIG. 13. In the fifth embodiment, the shape of a case lid portion 140 that constitutes a holding case of a power storage pack is different from the power storage unit 10 according to the first embodiment, and the basic structures are similar, and thus illustration of the other portions is omitted. In the fourth embodiment, the pack-side elastic contact portions 114 that are separate from the case lid portion 110 are attached to the case lid portion 110, but, in the fifth embodiment, pack-side elastic contact portions 142 are provided integrally with the case lid portion 110.

In the fifth embodiment, on the two sides in the left-right direction of the case lid portion 140, the pack-side elastic contact portions 142 are provided at two locations spaced apart from each other in the front-rear direction, but the pack-side elastic contact portions 142 are similar in shape to each other, and thus one of the pack-side elastic contact portions 142 will be described.

### Pack-side Elastic Contact Portions 142

Substantially rectangular through windows 144 that pass through the case lid portion 140 in the thickness direction (the up-down direction) are provided at predetermined positions of the case lid portion 140, and the pack-side elastic contact portions 142 that are curved to form upward protrusions and protrude inward in the left-right direction are provided on the inner peripheral surfaces on the outer sides in the left-right direction of the through windows 144. The pack-side elastic contact portions 142 each have smaller sizes in the front-rear direction and left-right direction than the through window 144, and a space (gap) is provided on three sides (the two sides in the front-rear direction and the inner side in the left-right direction) around each of the pack-side elastic contact portions 142. Accordingly, the pack-side elastic contact portions 142 are elastically deformable in the thickness direction. In the fifth embodiment, the pack-side elastic contact portions 142 are configured by elastic tongue pieces integrally provided on the upper side of the case lid portion 140, that is to say, the flat metal fitting (not illustrated) side. Note that, similarly to the flat metal fitting 112 according to the fourth embodiment, a flat metal fitting that has a substantially flat plate shape overall can be adopted as the flat metal fitting according to the fifth embodiment, and the opening portions 126 according to the fourth embodiment do not need to be provided.

Also in the fifth embodiment, by the flat metal fitting opposing the case lid portion 140 that includes the pack-side elastic contact portions 142 and being fixed to the case lid portion 140 in the up-down direction, the pack-side elastic contact portions 142 are pressed to the flat metal fitting. Accordingly, effects similar to those of the fourth embodiment can be exerted. Particularly, in the fifth embodiment, the pack-side elastic contact portions 142 are formed integrally with the case lid portion 140, making it possible to form the pack-side elastic contact portions 142 easily and inexpensively, and accordingly improving the manufacturability of the power storage unit and reducing the cost.

### Modified Examples

The first to fifth embodiments have been described above in detail as specific examples of the present disclosure, but the present disclosure is not limited to such specific description. Deformation, improvements, and the like within a range where an object of the present disclosure can be achieved are included in the present disclosure. The following modified examples of the embodiments are also included in the technical scope of the present disclosure, for example.

In the above embodiments, both the upper case 42 and the lower case 40 that constitute the box 18 that is made of metal are also made of metal, but, for example, the upper case may be made of a synthetic resin. In addition, it is sufficient that at least the bottom wall portion of the lower case that includes the placement surface that constitutes the pressurizing member is made of metal. Accordingly, it is possible to suppress expansion of the power storage elements that mainly expand in the up-down direction. That is to say, a configuration may also be adopted in which the peripheral wall portion of the lower case is made of a synthetic resin, and the lower case is made of a composite material of metal and a synthetic resin, but, for example, when expansion of the power storage elements in the left-right direction and the front-rear direction is envisioned, it is preferable that the peripheral wall portion is also made of metal such that the entirety of the lower case is made of metal.

In the second embodiment, the fitting-side elastic contact portions 70 separate from the flat metal fitting 72 are attached to the flat metal fitting 72 from above and are fixed thereto through recess/projection fitting, but fitting-side elastic contact portions separate from a flat metal fitting may be fixed to the flat metal fitting through welding or adhesion. In this case, the flat metal fitting does not need to be provided with through windows for attaching the fitting-side elastic contact portions. Similarly, in the fourth embodiment, the pack-side elastic contact portions 114 separate from the case lid portion 110 are attached to the case lid portion 110 from above, but may be fixed thereto through welding or adhesion.

The shapes of fitting-side elastic contact portions that are provided on a flat metal fitting and pack-side elastic contact portions that are provided on a holding case (case lid portion) are not limited. In the first embodiment, for example, the fitting-side elastic contact portions 54 protrude outward in the left-right direction from the inner peripheral surfaces on the inner side in the left-right direction of the through windows 52, but the fitting-side elastic contact portions may protrude inward in the left-right direction from the inner peripheral surfaces on the outer side in the left-right direction of the through windows. Similarly, the curved portions 74 of the fitting-side elastic contact portions 70 according to the second embodiment may be provided on the inner side in the left-right direction, and, in the fifth embodiment, the pack-side elastic contact portions 142 may protrude outward in the left-right direction from the inner peripheral surfaces on the inner side in the left-right direction of the through windows 144. In addition, also in the third embodiment, the fitting-side elastic contact portions 54 may protrude inward in the left-right direction, and the positions of guide surfaces that come into contact with the fitting-side elastic contact portions and guide the flat metal fitting 22 to a defined position may be changed in accordance with the protruding directions of the fitting-side elastic contact portions and the like. Note that, in the above embodiments, both the fitting-side elastic contact portions and the pack-side elastic contact portions protrude and extend in the left-right direction, but may protrude and extend in the front-rear direction in place of or in addition to the left-right direction.

In the above embodiments, the plurality of fitting-side elastic contact portions 54 and the plurality of fitting-side elastic contact portions 70, or the plurality of pack-side elastic contact portions 114 and the plurality of pack-side elastic contact portions 142 are provided, but the above embodiments are merely exemplary, and the number of fitting-side elastic contact portions or pack-side elastic contact portions may be one, and a different number of fitting-side elastic contact portions or a different number of pack-side elastic contact portions from those of the above embodiments may be provided.

At least two of the first to fifth embodiments may be adopted in combination. Integral fitting-side elastic contact portions such as those of the first embodiment may be provided on one side in the left-right direction of a flat metal fitting, or separate fitting-side elastic contact portions such as those of the second embodiment may be attached on the other side in the left-right direction. Similarly, separate pack-side elastic contact portions such as those of the fourth embodiment may be attached on one side in the front-rear direction of the case lid portion, or integral pack-side elastic contact portions such as those of the fifth embodiment may be provided on the other side in the front-rear direction. Furthermore, as with the fourth and fifth embodiments, a configuration may also be adopted in which, when the pack-side elastic contact portions 114 and 142 are provided on the case lid portions 110 and 140, guide surfaces that guide a flat metal fitting to a defined position are provided on the lower surface of the flat metal fitting, and come into contact with the pack-side elastic contact portions. In addition, for example, fitting-side elastic contact portions and pack-side elastic contact portions may be adopted in combination, and, for example, a configuration may also be adopted in which fitting-side elastic contact portions are provided on one side in the left-right direction of a flat metal fitting, and pack-side elastic contact portions are provided on the other side in the left-right direction of a holding case (case lid portion).

When separate fitting-side elastic contact portions or pack-side elastic contact portions are provided on a flat metal fitting or a holding case (case lid portion), there is no limitation to a metal piece (plate spring) that includes a curved portion such as that described in the above embodiment, and, for example, a coil spring or the like may also be used.

In the first embodiment, in a state where the power storage elements 12 (the first third power storage elements 12a to 12c) are not expanding, the expansion suppressing portion 59 that is an intermediate portion in the left-right direction of the flat metal fitting 22 and an intermediate portion in the left right direction of the case lid portion 36 are spaced apart from each other in the up-down direction, but, in a state where the power storage elements are not expanding, an intermediate portion in the left-right direction of the flat metal fitting (expansion suppressing portion) and an intermediate portion in the left-right direction of the case lid portion may abut on each other in the up-down direction.

As long as the power storage pack includes a power storage element and a holding case that holds the power storage element, the specific shape thereof is not limited. The number of power storage elements is not limited, for example, and may also be one, two, or four or more. A configuration may also be adopted in which holders that hold power storage elements are provided in correspondence with the number of power storage elements, and are overlaid and attached as with the above embodiments, but, for example, one box that accommodates all of the power storage elements may also be used.

In the power storage unit according to the present disclosure, the specific structure of the box or the like that accommodates the power storage pack is not limited, and, for example, the structure for fixing the flat metal fitting to the box (lower case) is also not limited to the power storage pack. The flat metal fitting may be fixed to the upper case that constitutes the box, for example.

1. A power storage unit comprising:
a power storage pack that includes a power storage element and a holding case that holds the power storage element;
a control board that is connected to the power storage pack;
a box that accommodates the power storage pack and the control board,; and
a flat metal fitting that is disposed to oppose, in the box, a metal placement surface for the power storage pack with the power storage pack intervening therebetween, and is fixed to the box,
wherein the placement surface and the flat metal fitting form a pressurizing member that suppresses expansion of the power storage element.

2. The power storage unit according to claim 1,
wherein the flat metal fitting includes a fitting-side elastic contact portion that is in elastic contact with the power storage pack.

3. The power storage unit according to claim 2,
wherein the fitting-side elastic contact portion is constituted by a spring piece formed by cutting a portion of the flat metal fitting and raising the portion to the power storage pack side.

4. The power storage unit according to claim 2,
wherein the fitting-side elastic contact portion is constituted by a separate spring member that is to be attached to the flat metal fitting.

5. The power storage unit according to claim 1,
wherein the holding case of the power storage pack includes a pack-side elastic contact portion that is in elastic contact with the flat metal fitting.

6. The power storage unit according to claim 5,
wherein the pack-side elastic contact portion is constituted by an elastic tongue piece provided integrally with the holding case, on the flat metal fitting side of the holding case.

7. The power storage unit according to claim 5,
wherein the pack-side elastic contact portion is constituted by a separate spring member that is to be attached to the holding case.

8. The power storage unit according to claim 2,
wherein the power storage pack is provided with a guide surface that leads the fitting-side elastic contact portion to a defined position.

9. The power storage unit according to claim 3,
wherein the power storage pack is provided with a guide surface that leads the fitting-side elastic contact portion to a defined position.

10. The power storage unit according to claim 4,
wherein the power storage pack is provided with a guide surface that leads the fitting-side elastic contact portion to a defined position.
